(19) United States
(12) Patent Application Publication
(10) Pub. No.: US 2014/0160237 A1
(43) Pub. Date: Jun. 12, 2014

(54) VIDEO SIGNAL CONTROL DEVICE, VIDEO SIGNAL CONTROL METHOD, AND DISPLAY DEVICE

(71) Applicants: Ryoh Araki, Osaka-shi (JP); Toshihiro Yanagi, Osaka-shi (JP); Yoshinobu Hirayama, Osaka-shi (JP); Kenichiroh Yamaki, Osaka-shi (JP)

(72) Inventors: Ryoh Araki, Osaka-shi (JP); Toshihiro Yanagi, Osaka-shi (JP); Yoshinobu Hirayama, Osaka-shi (JP); Kenichiroh Yamaki, Osaka-shi (JP)

(73) Assignee: SHARP KABUSHIKI KAISHA, Osaka-shi, Osaka (JP)

(21) Appl. No.: 14/232,957

(22) PCT Filed: Jul. 18, 2012
(86) PCT No.: PCT/JP2012/068249

§ 371 Date: Jan. 15, 2014

(30) Foreign Application Priority Data
Jul. 22, 2011 (JP) 2011-160820

(51) Int. Cl. H04N 13/00; H04N 13/04

(52) U.S. Cl. CPC H04N 13/0018; H04N 13/0447; H04N 13/0438
USPC 348/42

(57) ABSTRACT

A black line inserting section (3) inserts first grayscale inserts first grayscale lines, each of which has a color of certain grayscale and has a width corresponding to a certain number of pixels, into each of first video images such that a certain distance is secured, between the respective first grayscale lines, in a vertical or horizontal direction of each of the first video images. The black line inserting section (3) also inserts second grayscale lines into each of second video images, which corresponds to a certain number of frames and by which a corresponding one of the first video images is followed, such that the second grayscale lines are not inserted into second parts corresponding to first parts where the respective first grayscale lines are inserted.

### TECHNICAL FIELD

The present invention relates to (i) a video signal controlling device (video signal control device) for processing a video signal containing a single video image per frame, (ii) a method of processing a video signal (video signal control method), and (iii) a display device including the video signal controlling device.

### BACKGROUND ART

Conventionally, display devices are known which allow a plurality of viewers to simultaneously view different video images on a single display screen. Such a display device is configured to alternately input and output respective items of video data for the plurality of viewers. According to this configuration, the viewers each need to wear active shutter glasses. High-speed switching between video images displayed on the display device and high-speed switching between opening and closing of active shutter glasses (i.e. switching between enlarging and blocking of the glasses' fields of view (viewers' views)) are carried out in synchronization. This allows, with the use of a single display screen, a plurality of viewers to view respective video images simultaneously. Such a display device is called a dual-view display of an active shutter type. Hereinafter, (i) to “open glasses” means to enlarge a field of view of a viewer and (ii) to “close glasses” means to block a field of view of a viewer.

In a case where two viewers (hereinafter referred to as “viewer A” and “viewer B”) attempt to view different video images with the use of such a display device, the viewer A and the viewer B wear glasses a and glasses b, respectively. While a video image for the viewer A is displayed on a display screen of the display device, only the glasses a are opened. This allows only the viewer A to view the video image. On the other hand, while a video image for the viewer B is displayed on the display screen of the display device, only the glasses b are opened. This allows only the viewer B to view the video image.

According to such a display device, the glasses a are opened at a time point at which writing of the video image for the viewer A is ended during one frame. This allows only the viewer A to view the video image. Then, the glasses b are opened at a time point at which writing of the video image for the viewer B is ended during a following frame. This allows only the viewer B to view the video image.

However, in a case where a response speed of the display device with respect to switching from the video image for the viewer A to the video image for the viewer B is slow, the glasses b may be opened before the writing of the video image for the viewer B. In such a case, the video image of the preceding frame (video image for the viewer A) and the video image of the following frame (video image for the viewer B) become mixed with each other. Such a mixture of video images is called “crosstalk.”

As a technique for preventing the crosstalk, a technique is known in which a video image of a certain grayscale is displayed all over a screen of a video display section during at least one of two sub-frames into which one frame is divided (see Patent Literature 1, for example).

### Citation List

### Patent Literature

Patent Literature 1
Japanese Patent Application Publication, Tokukai, No. 2011-124939 A (Publication Date: Jun. 23, 2011)

### SUMMARY OF INVENTION

### Technical Problem

According to the technique of Patent Literature 1, (i) one frame is divided into two sub-frames and (ii) an image of a certain grayscale is displayed all over a screen of a video display section during at least one of the two sub-frames. This causes an image of any grayscale to be provided in a half of a given frame, and therefore causes a reduction in the length of time per frame, for which length the image is displayed. Hence, in a case where a response speed of a display device is slow, the effects of reducing crosstalk are little.

FIG. 12 is a view illustrating video images displayed on a conventional display device. (a) of FIG. 12 is a view illustrating video images displayed on the display device in a case where a timing at which to switch between the video images and a timing at which to switch between opening and closing of shutter glasses match each other. (b) of FIG. 12 is a view illustrating video images displayed on the display device in a case where a timing at which to switch between the video images and a timing at which to switch between opening and closing of the glasses differ from each other.

Respective images of an Nth frame and of an (N+2)th frame illustrated in (a) of FIG. 12 are images displayed for a viewer A in a case where the timing of video image switching and the timing of opening/closing switching of the shutter glasses match each other. An image of an (N+1)th frame illustrated in (a) of FIG. 12 is an image for a viewer B in the case where the timing of video image switching and the timing of opening/closing switching of the shutter glasses match each other.

As illustrated in (b) of FIG. 12, in a case where the timing of video image switching and the timing of opening/closing switching of the shutter glasses differ from each other, the images for the viewer B are displayed simultaneously with the images for the viewer A in the Nth and the (N+2)th frames. In other words, crosstalk is occurring.

In the (N+1)th frame, on the other hand, the image for the viewer A is displayed simultaneously with the image for the viewer B; crosstalk is occurring. In such conditions, not only are images mixed with each other, but a background color is also mixed with the images.

The present invention has been made in view of the problem. According to an embodiment of the present invention, it is possible to provide a video signal with a characteristic that reduces the occurrence of crosstalk while a video image is displayed.

### Solution to Problem

In order to attain the object, a video signal controlling device of the present invention is a video signal controlling device for processing a video signal which indicates video images in respective frames, including: a grayscale line inserting section for (i) inserting first grayscale lines, each of which has a color of certain grayscale and has a width corresponding to a certain number of pixels, into each of first video images such that a certain distance is secured, between the respective first grayscale lines, in a vertical or horizontal direction of each of the first video images and (ii) inserting second grayscale lines into each of second video images, which corresponds to a certain number of frames and by which a corresponding one of the first video images is followed, such that the second grayscale lines are not inserted into second parts corresponding to first parts where the respective first grayscale lines are inserted.

According to the configuration, a video signal, which has been processed by the video signal controlling device is configured such that (i) first grayscale lines, each of which has a color of certain grayscale and has a width corresponding to a certain number of pixels, are inserted into each of first video images such that a certain distance is secured, between the respective first grayscale lines, in a vertical or horizontal direction of each of the first video images and (ii) second grayscale lines are inserted into each of second video images, which corresponds to a certain number of frames and by which a corresponding one of the first video images is followed, such that the second grayscale lines are not inserted into second parts corresponding to first parts where the respective first grayscale lines are inserted. For example, black grayscale lines are inserted into odd-numbered lines of a video image of any given frame whereas other black grayscale lines are inserted into even-numbered lines of a video image of a following frame.

Hence, even in a case where a video image of a current frame is mixed with a video image of a preceding frame, the video image of the current frame is displayed on a part of a screen which part was displaying, in the preceding frame, not the video image but grayscale lines. In other words, even in a case where crosstalk occurs, it is a video image and grayscale lines that are mixed with each other. In addition, grayscale lines of the current frames are displayed on a part of the screen which part was displaying the video image in the preceding frame. In other words, even in the case where crosstalk occurs, it is a video image and grayscale lines that are mixed with each other.

Therefore, in a case where a display device displays video images with the use of a video signal which has been processed by the video signal controlling device of the present invention, video images are never mixed with one another even if crosstalk occurs.

The video signal controlling device of the present invention thus brings about such an advantageous effect as providing a video signal with a characteristic of reducing the occurrence of crosstalk while a video image is displayed. Such processing carried out by the video signal controlling device is particularly effective in using a video signal configured so that respective images for a plurality of viewers are switched therebetween per specific frame unit.

In order to attain the object, a method of the present invention is a method of processing a video signal which indicates video images in respective frames, said method including the step of: (i) inserting first grayscale lines, each of which has a color of certain grayscale and has a width corresponding to a certain number of pixels, into each of first video images such that a certain distance is secured, between the respective first grayscale lines, in a vertical or horizontal direction of each of the first video images and (ii) inserting second grayscale lines into each of second video images, which corresponds to a certain number of frames and by which a corresponding one of the first video images is followed, such that the second grayscale lines are not inserted into second parts corresponding to first parts where the respective first grayscale lines are inserted.

With the method, it is possible to bring about an advantageous effect identical to that brought about by the video signal controlling device of the present invention. Additional objects, features, and strengths of the present invention will be made clear by the description below. Further, the advantages of the present invention will be evident from the following explanation in reference to the drawings.

### Advantageous Effects of Invention

A video signal controlling device of the present invention brings about such advantageous effects as providing a video signal with a characteristic of reducing the occurrence of crosstalk while a video image is displayed.

### BRIEF DESCRIPTION OF DRAWINGS

FIG. 1 is a block diagram illustrating a main configuration of a display system in accordance with an embodiment of the present invention.

FIG. 2 is a view illustrating switching between video images displayed on the display system in accordance with the embodiment of the present invention.

FIG. 3 is a view illustrating video data in accordance with the embodiment of the present invention.

FIG. 4 is a set of timings charts (a) and (b), (a) of FIG. 4 illustrating a state in which there is a match between (i) timings of switching between video images displayed on the display device in accordance with the embodiment of the present invention and (ii) timings of opening/closing of shutter glasses and (b) of FIG. 4 illustrating a state in which there is a difference between (i) timings of switching between video images displayed on the display device in accordance with the embodiment of the present invention and (ii) timings of opening/closing of shutter glasses.

FIG. 5 is a set of views (a) and (b), (a) of FIG. 5 illustrating video images displayed on the display device in accordance with the embodiment of the present invention in a case where there is a match between (i) timings of switching between the video images displayed on the display device and (ii) timings of switching between opening/closing of shutter glasses and (b) of FIG. 5 illustrating video images displayed on the display device in accordance with the embodiment of the present invention in a case where there is a difference between (i) timings of switching between the video images displayed on the display device and (ii) timings of switching between opening/closing of shutter glasses.

FIG. 6 is a view illustrating video data in accordance with Embodiment 2 of the present invention.

FIG. 7 is a block diagram illustrating a main configuration of a display system in accordance with Embodiment 3 of the present invention.

FIG. 8 is a view illustrating how video images are displayed on the display system in accordance with Embodiment 3 of the present invention.

FIG. 9 is a view illustrating video data in accordance with Embodiment 3 of the present invention.

FIG. 10 is a view illustrating video data in accordance with Embodiment 4 of the present invention.

FIG. 11 is a block diagram illustrating a main configuration of a display system in accordance with Embodiment 5 of the present invention.

FIG. 12 is a set of views (a) and (b), (a) of FIG. 12 illustrating video images displayed on a conventional display device in a case where there is a match between (i) timings at which the video images are switched and (ii) timings at which opening/closing of shutter glasses are switched and (b) of FIG. 12 illustrating video images displayed on a conventional display device in a case where there is a difference between (i) timings at which the video images are switched and (ii) timings at which opening/closing of shutter glasses are switched.

### DESCRIPTION OF EMBODIMENTS

The following description will discuss, in detail, embodiments of a display device in accordance with the present invention.

### Embodiment 1

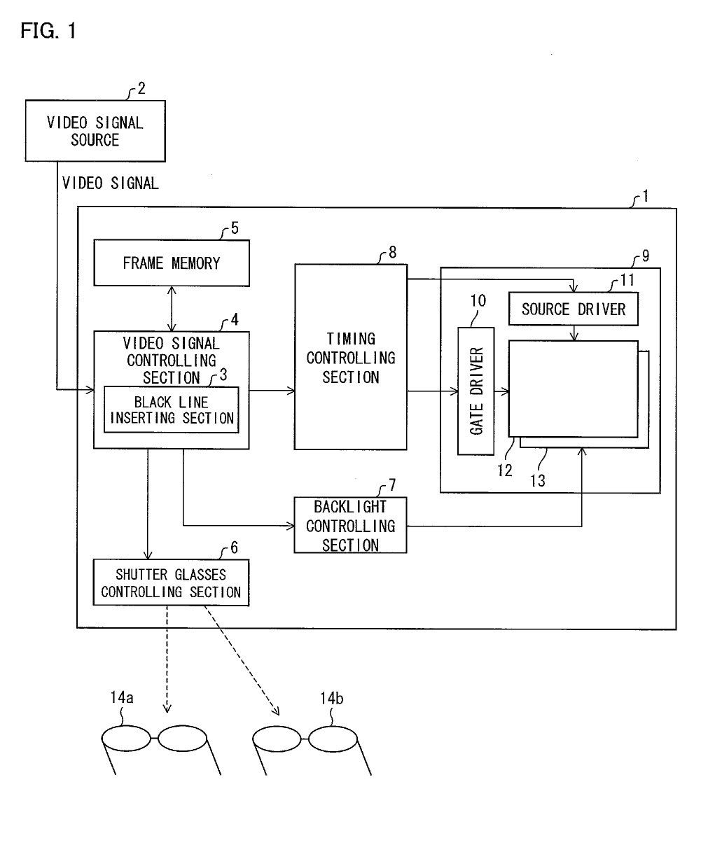

Embodiment 1 of the display device in accordance with the present invention will be described below with reference to FIGS. 1 through 5.

(Displayed Device 1)

FIG. 1 is a block diagram illustrating a main configuration of a displayed system in accordance with an embodiment of the present invention. As illustrated in FIG. 1, the display system includes a display device 1, a video signal source 2, shutter glasses 14a, and shutter glasses 14b. The display device 1 includes a video signal controlling section 4, a frame memory 5, a shutter glasses controlling section 6, a backlight controlling section 7, a timing controlling section 8, and a display section 9. The video signal controlling section 4 includes a black line inserting section 3. The display section 9 includes a display panel 12, a gate driver 10, a source driver 11, and a backlight 13. The display device 1 is connected to the video signal source 2.

(Video Signal Source 2)

The video signal source 2 is a device, such as a personal computer, a gaming device, or a remote computer, which has a function to output a video signal to an external device. The video signal source 2 supplies, to the display device 1, video signals each providing a video image to be viewed by a viewer. In accordance with the video signals supplied from the video signal source 2, the display device 1 causes the display panel 12 to display the video images.

(Video Signal Controlling Section 4)

The video signal controlling section 4 receives video signals from the video signal source 2. The video signal controlling section 4 processes the video signals thus received, and then supplies a processed video signal to the timing controlling section 8. The details of the processing will be described later. The video signal controlling section 4 also (i) generates, based on the video signals thus received, predetermined controlling signals and then (ii) supplies the controlling signals to respective of the shutter glasses controlling section 6 and the backlight controlling section 7.

(Backlight 7)

In accordance with the controlling signal supplied from the video signal controlling section 4, the backlight controlling section 7 generates a backlight controlling signal for controlling timings at which the backlight 13 is to be turned on. Then, the backlight controlling section 7 supplies the backlight controlling signal to the backlight controlling section 7. The backlight 13 operates in accordance with the backlight controlling signal.

(Shutter Glasses Controlling Section 6)

In accordance with the controlling signal supplied from the video signal controlling section 4, the shutter glasses controlling section 6 separately generates (i) a controlling signal A for controlling opening/closing motions of the shutter glasses 14a and (ii) a controlling signal B for controlling opening/closing motions of the shutter glasses 14b. Then, the shutter glasses controlling section 6 supplies the controlling signals A and B to the shutter glasses 14a and the shutter glasses 14b, respectively. In so doing, the controlling signals A and B are each supplied in the form of infrared light. Specifically, the controlling signals A and B in the form of infrared light are each transmitted, via an infrared light emitter (not illustrated) included in the display device 1, to the shutter glasses 14a and the shutter glasses 14b, respectively. The shutter glasses 14a and the shutter glasses 14b each receive the controlling signal via a receiving section thereof.

A type of each of the controlling signals A and B is not limited to infrared light. That is, it is possible for the shutter glasses controlling section 6 to output any desired wireless signals as the respective controlling signals A and B. Examples of such a wireless signal encompass Bluetooth (registered trademark) and a high-frequency electromagnetic ray.

(Shutter Glasses 14a and 14b)

The shutter glasses 14a and 14b each allow a viewer to view a video image displayed on the display section 9. The shutter glasses 14a and 14b each have lenses each provided with a shutter. The shutter blocks and enlarges the lens' field of view (viewer's field of view). This causes a video image displayed on the display panel 12 to be blocked by and pass through the lens, respectively. Specifically, the shutter glasses 14a and 14b are opened or closed by controlling signals supplied from the shutter glasses controlling section 6.

(Video Signal Control)

The video signal controlling section 4 carries out various kinds of signal processing with respect to video signals which have been supplied from the video signal source 2. This causes the video signals to be converted into a video signal capable of dual-view display. Specifically, (i) the video signals supplied from the video signal source 2 are video signals for respective first and second viewers and (ii) the video signal controlling section 4 converts the video signals so that (a) video images contained in the video signal for the first viewer and (b) video images included in the video signal for the second viewer, are alternated in a converted video signal. In other words, the video signal controlling section 4 generates a video signal for displaying the video images for the respective first and second viewers alternately and time-divisionally.

(Example of Video Image Display)

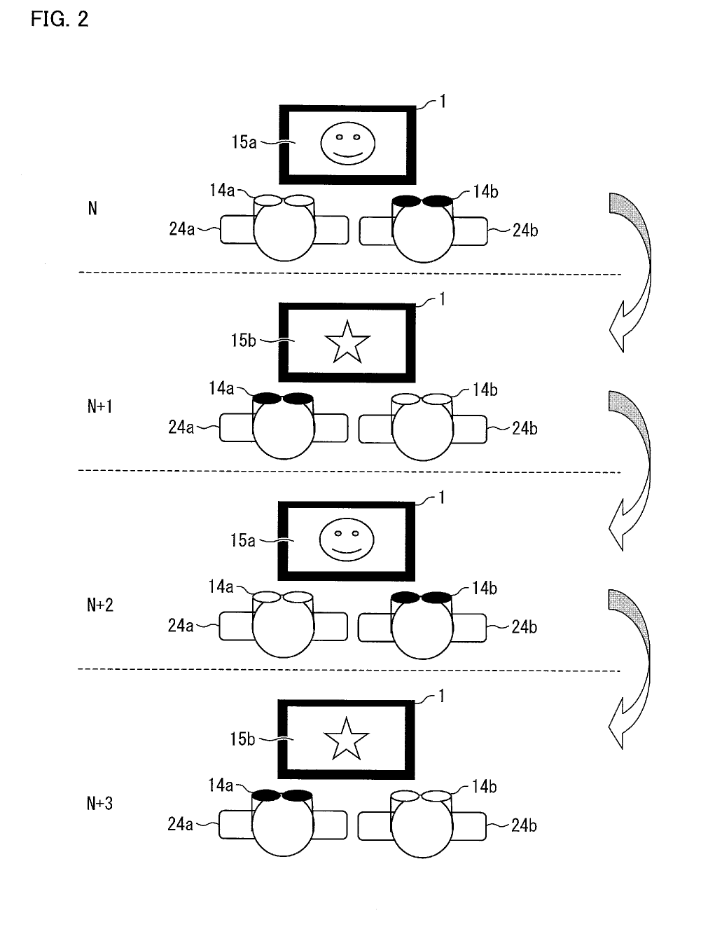

The display device 1 is a device capable of dual-view display. Specifically, the display device 1 allows, with the use of a single display screen, a plurality of viewers to simultaneously view different video images containing respective contents. FIG. 2 is a view illustrating switching between video images displayed on the display device 1 in accordance with the embodiment of the present invention. Note that “Nth”, “(N+1)th”, and the like, illustrated in FIG. 2, each indicate a frame in which a video image is displayed on the display device 1. Viewers 24a and 24b, each of whom is to view a video image displayed on the display device 1, are present in front of the display screen of the display device 1. The viewers 24a and 24b are wearing shutter glasses 14a and 14b, respectively. According to Embodiment 1, it is possible for the two persons, the viewers 24a and 24b, to share a single display device 1 while simultaneously viewing their respective different video images on the single display device 1.

During the Nth frame, the display device 1 displays a video image 15a intended for the viewer 24a. During the Nth frame, the shutter glasses 14a are open whereas the shutter glasses 14b are closed. This allows only the viewer 24a to view the video image 15a.

During the following (N+1)th frame, the display device 1 displays a video image 15b intended for the viewer 24b. During the (N+1)th frame, the shutter glasses 14b are opened whereas the shutter glasses 14a are closed. This allows only the viewer 24b to view the video image 15b.

During the following (N+2)th frame, the display device 1 displays the video image 15a intended for the viewer 24a. During the (N+2)th frame, the shutter glasses 14a are open whereas the shutter glasses 14b are closed. This allows only the viewer 24a to view the video image 15a.

During the following (N+3)th frame, the display device 1 displays a video image 15b intended for the viewer 24b. During the (N+3)th frame, the shutter glasses 14b are opened whereas the shutter glasses 14a are closed. This allows only the viewer 24b to view the video image 15b.

The display device 1 thus displays the video images 15a and 15b such that that they alternate at a high speed for each frame. Furthermore, in synchronization with such display, the display device 1 controls opening and closing of the shutter glasses 14a and 14b. This (i) causes the viewer 24a to view, at a constant frequency, the video image 15a via the shutter glasses 14a and (ii) causes the viewer 24b to view, at a constant frequency, the video image 15b via the shutter glasses 14b. It is therefore possible for the viewers 24a and 24b to simultaneously view, with the use of the single display device 1, different video images containing respective contents.

(Insertion of Black Lines into Video Image)

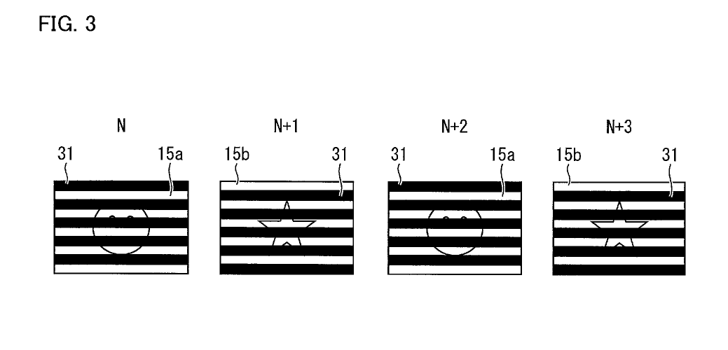

According to the display device 1, while the video signal controlling section 4 is processing supplied video signals, the black line inserting section 3 inserts black lines 31 into video images. The following description will discuss the insertion of black lines 31. FIG. 3 is a view illustrating video images into which the black lines 31 are inserted in the embodiment of the present invention.

The black line inserting section 3 inserts, into video images 15a for a viewer 24a and into video images 15b for a viewer 24b, horizontal black lines 31 each corresponding to 1 (one) horizontal line in a corresponding frame. In so doing, the black lines 31 are inserted into odd-numbered lines of the video images 15a while being inserted into even-numbered lines of the video images 15b. According to a processed video signal, black lines 31, which are inserted into a video image of any given frame, are therefore shifted by one line from black lines 31 which are inserted into a video image of a following frame.

Specifically, as illustrated in FIG. 3, the black lines 31 are inserted into odd-numbered lines of video images of an Nth frame and an (N+2)th frame, which are video images 15a intended for the viewer 24a. On the other hand, the black lines 31 are inserted into even-numbered lines of video images of an (N+1)th frame and an (N+3)th frame, which are video images 15b intended for the viewer 24b. The video signal controlling section 4 (i) generates a video signal in which video images 15a containing black lines 31 and video images 15b containing black lines 31 are alternated as such and then (ii) supplies the video signal to the timing controlling section 8.

Note that each of black lines 31 is merely as extremely thin as a single horizontal line of a video image. This causes neither viewer 24a nor viewer 24b to recognize the black lines 31 while the black lines 31 are being displayed on the display panel 12. Therefore, although the overall brightness becomes somewhat dark, the video images 15a containing the black lines 31 and the video images 15b containing the black lines 31 maintain their original display quality unlike the case without the black lines 31.

(Crosstalk)

According to Embodiment 1, in a case where opening/closing frequencies of the respective shutter glasses 14a and 14b fall below 60 Hz (16.7 ms per frame), a viewer perceives, as a flicking part, part of the display screen which part has, for example, a high luminance. Therefore, the opening/closing frequencies of the respective shutter glasses 14a and 14b are preferably 60 Hz or more. Note that, in a case where the frequencies of the respective shutter glasses 14a and 14b are set to be 60 Hz or more, a frame rate of the display panel 12 needs to be set to 120 Hz (8.3 ms per frame) or more.

In a case where a video image is rewritten at such a high frame rate, however, there is a possibility that a response speed of the display device 1 cannot keep up with the rewriting of the video image, and consequently timings of the video rewriting may differ from timings of switching between the shutter glasses 14a and 14b. In such a case, respective video images of a preceding frame and a following frame would become mixed (i.e. crosstalk occurs). This causes deterioration in display quality.

According to Embodiment 1, however, the black lines are inserted into a video image of each frame, and therefore a location of black lines of a frame differ from a location of black lines of a following frame. Therefore, even in a case where there is a part where respective video images of a preceding frame and a following frame are mixed, such a part corresponds to a part where a black line is inserted. This prevents a viewer from perceiving the crosstalk on the video image (although the viewer may perceive slight darkness in the video image). Therefore, according to Embodiment 1, the occurrence of crosstalk can be reduced.

(Advantages of Insertion of Black Lines)

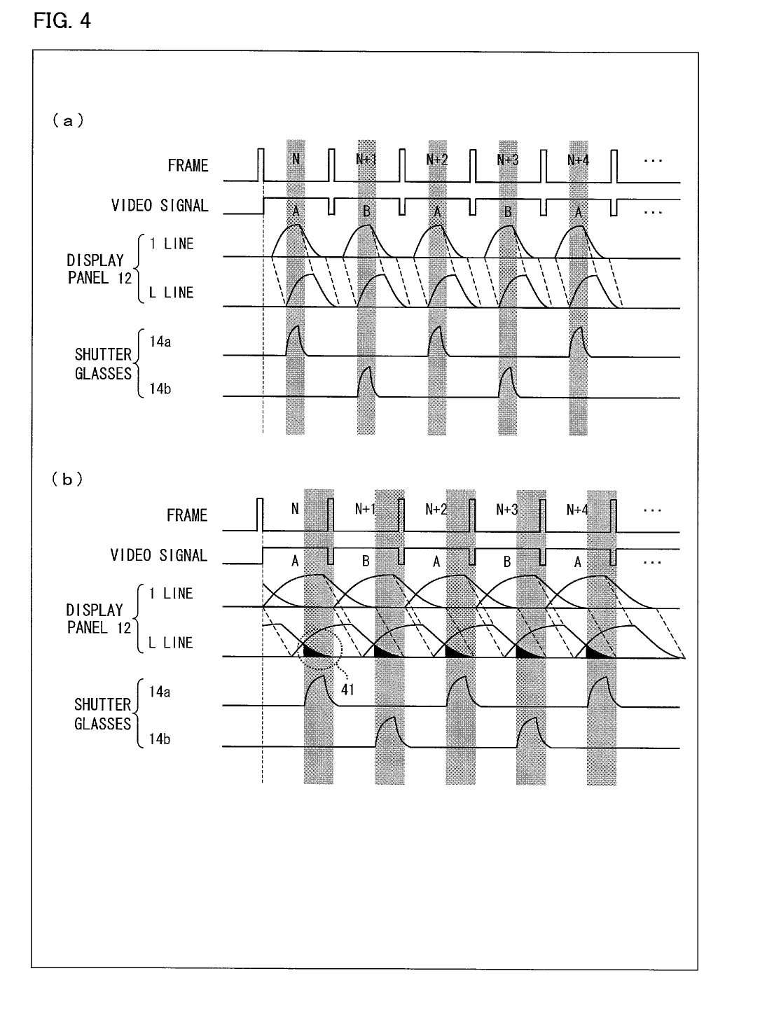

(a) of FIG. 4 is a timing chart illustrating a state in which there is a match between (i) timings of switching between video images displayed on the display device 1 in accordance with the embodiment of the present invention and (ii) timings of opening/closing of shutter glasses. In contrast, (b) of FIG. 4 is a timing chart illustrating a state in which there is a difference between (i) timings of switching between video images displayed on the display device 1 in accordance with the embodiment of the present invention and (ii) timings of opening/closing of shutter glasses.

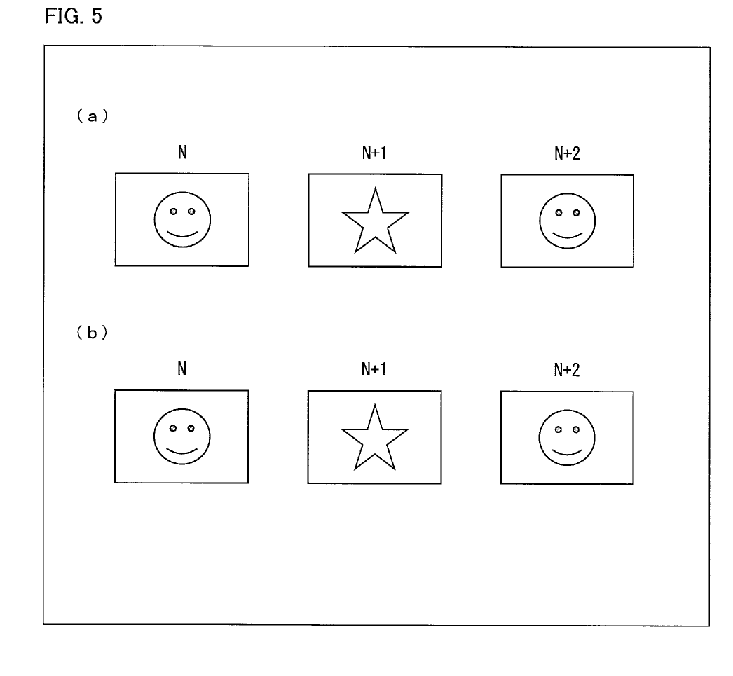

(a) of FIG. 5 is a view illustrating video images displayed on the display device 1 in a case where there is a match between (i) timings of switching between the video images displayed on the display device 1 and (ii) timings of switching between opening/closing of shutter glasses. In contrast, (b) of FIG. 5 is a view illustrating video images displayed on the display device 1 in a case where there is a difference between (i) timings of switching between the video images displayed on the display device 1 and (ii) timings of switching between opening/closing of shutter glasses.

The display panel 12 writes video images onto pixels basically in order from a first line. Note that, in a case where a response speed of liquid crystals is sufficiently fast, a video image of a current frame will not become mixed with a video image of a preceding frame (see (a) of FIG. 4). This prevents crosstalk from occurring. As a result, the video images displayed on the display panel 12 becomes as illustrated in (a) of FIG. 5. That is, the video images are properly displayed in respective frames. Note that, in this regard, the same is true of a conventional display panel.

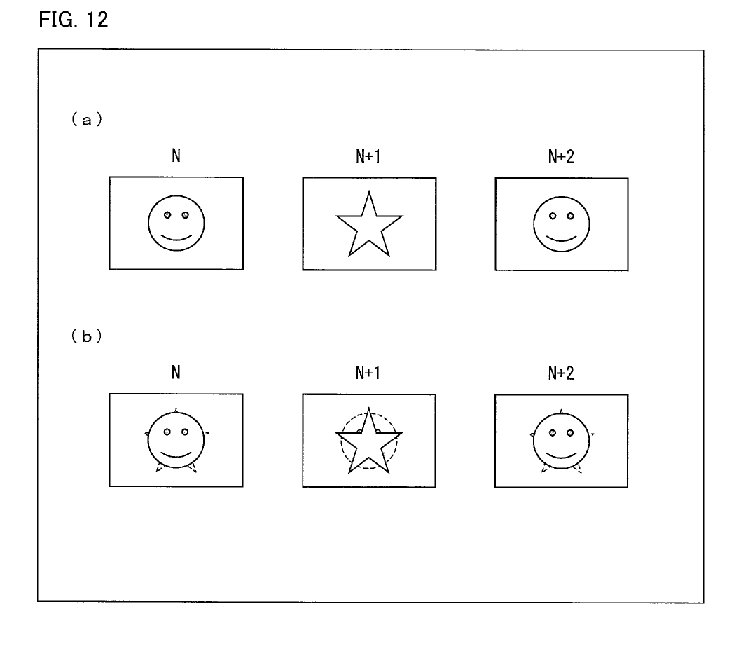

In a case where a response speed of liquid crystals is slow, however, a video image of a current frame becomes mixed with a video image of a preceding frame (see a part indicated as “41” in (b) of FIG. 4). This causes the occurrence of crosstalk. To make matters worse, the crosstalk occurs in each frame. As a result, according to the conventional display panel, a video image mixed with that of a preceding frame is displayed in each frame as illustrated in (b) of FIG. 12.

According to the display panel 12, on the other hand, even in a case where the video image 15b of the (N+1)th frame is mixed with the video image 15a of the Nth frame for example, a part of the display panel 12 which part displays the video image 15b in the (N+1)th frame corresponds to a part of the display panel 12 in the Nth frame which part did not display the video image 15a but the black lines 31. In other words, even in the case where the crosstalk occurs, the video image 15b and the black lines 31 are the ones that become mixed with each other. Furthermore, a part of the display panel 12 which part displays the black lines 31 in the (N+1)th corresponds to a part of the display panel 12 in the Nth frame which part displayed the video image 15a. In other words, even in the case where the crosstalk occurs, the video image 15a and the black lines 31 are the ones that become mixed with each other.

According to the display device 1 of Embodiment 1, as has been described, the video images 15a and 15b will never be mixed with each other even in a case where crosstalk occurs. This causes neither a viewer 24a nor a viewer 24b to perceive respective video images of a current frame and of a preceding frame being mixed with each other. In other words, the video images on the display panel 12 are displayed as illustrated in (b) of FIG. 5, that is, the video images are properly displayed.

### SUMMARY

According to the display device 1 of Embodiment 1, the black line inserting section 3 is included, and a plurality of black lines are inserted into video images displayed on the display device 1. This prevents crosstalk from occurring on the video images even in a case where a response speed of the display device 1 is slow so that timings of switching between the video images do not match timings of switching between the shutter glasses 14a and 14b.

### Embodiment 2

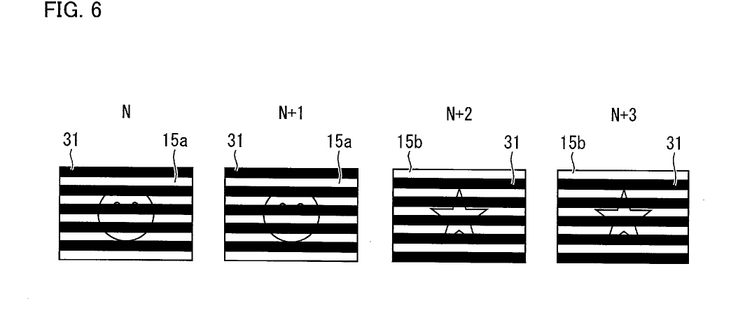

The following description will discuss Embodiment 2 with reference to FIG. 6. Note that members, which are similar to those described in Embodiment 1, are given the same reference signs, and their detailed descriptions will be omitted.

According to a display device 1 of Embodiment 2, a video signal controlling section 4 generates a video signal in which two frames of video images 15a intended for a viewer 24a and two frames of video images 15b intended for a viewer 24b are alternated. In so doing, a black line inserting section 3 (i) inserts black lines 31 into odd-numbered lines of each of the video images 15a and (ii) inserts black lines 31 into even-numbered lines of the video images 15b. This causes a video signal controlling section 4 to receive the video signal as illustrated in FIG. 6.

FIG. 6 is a view illustrating a video signal according to Embodiment 2. As illustrated in FIG. 6, (i) the black lines 31 are inserted into odd-numbered lines of the video images 15a in an Nth frame and an (N+1)th frame and (ii) the black lines 31 are inserted into the video images 15b in an (N+2)th frame and an (N+3)th frame. Therefore, when the display panel 12 displays a video image in such a manner, two adjacent frames of the video images 15a and two adjacent frames of video images 15b are alternated during display. It is thus possible to prevent, by consecutively displaying the same video images, crosstalk from occurring while video images are displayed. Furthermore, a crosstalk-reduction effect by insertion of the black lines 31 can also be obtained at the same time. In other words, a synergistic effect on reduction in crosstalk can be obtained.

According to the display device 1 of Embodiment 2, a further reduction in the occurrence of crosstalk can thus be achieved, as compared with the case where video images 15a and video images 15b alternate for each frame.

### Embodiment 3

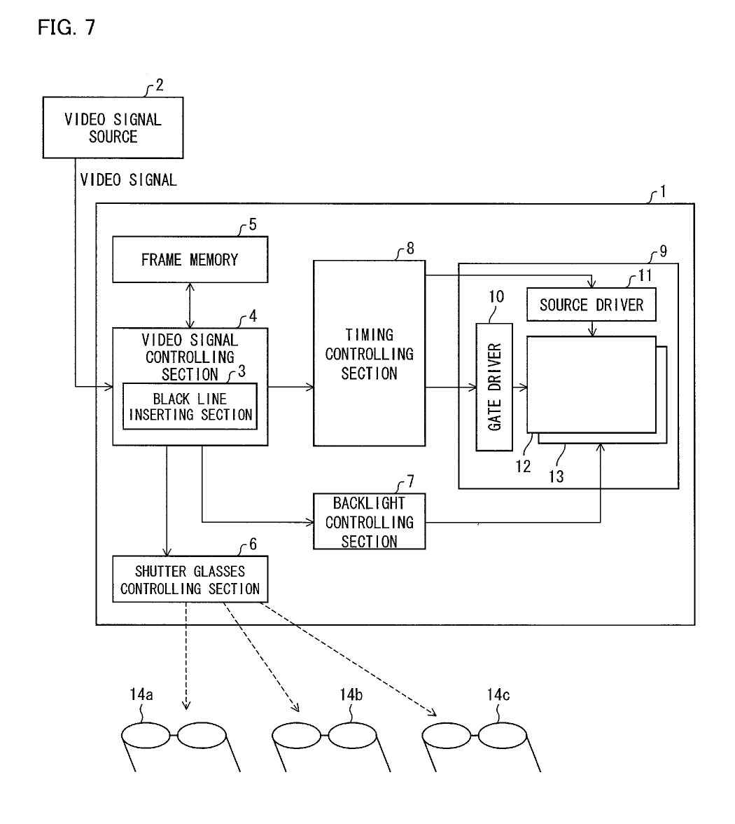

The following description will discuss Embodiment 3 of the present invention with reference to FIGS. 7 through 9. Note that members, which are similar to those described in Embodiment 1 or 2, are given the same reference signs, and their detailed descriptions will be omitted.

FIG. 7 is a block diagram illustrating a main configuration of a display system in accordance with Embodiment 3 of the present invention. As illustrated in FIG. 7, the display system of Embodiment 3 includes a display device 1, a video signal source 2, shutter glasses 14a, shutter glasses 14b, and shutter glasses 14c. The display device 1 of Embodiment 3 is identical in configuration to that of Embodiment 1. Unlike the shutter glasses controlling section 6 of Embodiment 1, however, a shutter glasses controlling section 6 of Embodiment 3 transmits a controlling signal to not only the shutter glasses 14a and 14b but also the shutter glasses 14c. A viewer 24c (third viewer) wears the shutter glasses 14c so as to view a video image while sharing the single display device 1 with the viewers 24a and 24b. Note that the viewer 24c views a video image that is different from both of respective video images to be viewed by the viewer 24c and by the viewer 24b.

(Example of Video Image Display)

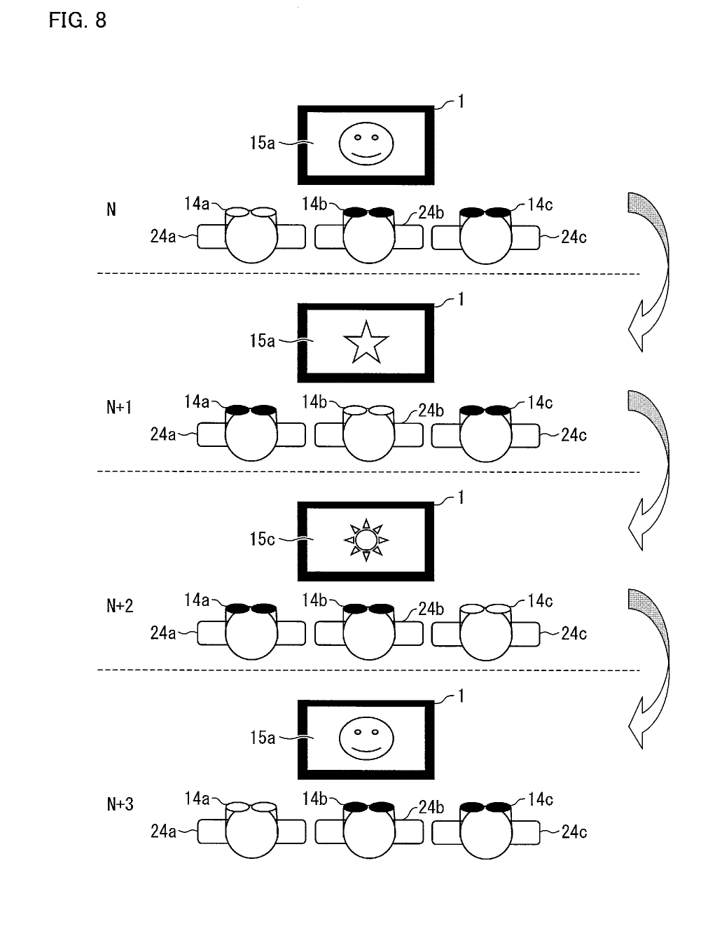

FIG. 8 is a view illustrating switching between video images displayed on the display device 1 of the embodiment. In FIG. 8, “Nth”, “(N+1)th”, and the like each indicate a frame in which a video image is displayed on the display device 1. Viewers 24a, 24b and 24c, each of whom is to view a video image displayed on the display device 1, are present in front of the display screen of the display device 1. The viewers 24a, 24b, and 24c are wearing shutter glasses 14a, 14b and 14c, respectively. According to Embodiment 3, the viewers 24a, 24b, and 24c share the single display device 1 while simultaneously viewing their respective different video images on the single display device 1.

During the Nth frame, the display device 1 displays a video image 15a intended for the viewer 24a. During the Nth frame, the shutter glasses 14a are open whereas neither the shutter glasses 14b nor 14c are opened. This allows only the viewer 24a to view the video image 15a.

During the following (N+1)th frame, the display device 1 displays a video image 15b intended for the viewer 24b. During the (N+1)th frame, the shutter glasses 14b are opened whereas neither the shutter glasses 14a nor 14c are opened. This allows only the viewer 24b to view the video image 15b.

During the following (N+2)th frame, the display device 1 displays a video image 15c intended for the viewer 24c. During the (N+2)th frame, the shutter glasses 14c are opened whereas neither the shutter glasses 14a nor 14b are opened. This allows only the viewer 24c to view the video image 15c.

During the following (N+3)th frame, the display device 1 displays a video image 15a intended for the viewer 24a. During the (N+3)th frame, the shutter glasses 14a are open whereas neither the shutter glasses 14b nor 14c are opened. This allows only the viewer 24a to view the video image 15a.

The display device 1 thus displays the video images 15a, 15b, and 15c such that that they are switched therebetween at a high speed. Furthermore, in synchronization with such display, the display device 1 individually controls opening or closing of the shutter glasses 14a, 14b, and 14c. This (i) causes the viewer 24a to view, at a constant frequency, the video image 15a via the shutter glasses 14a, (ii) causes the viewer 24b to view, at a constant frequency, the video image 15b via the shutter glasses 14b, and (iii) causes the viewer 24c to view, at a constant frequency, the video image 15c via the shutter glasses 14c. As a result, it is possible for the viewers 24a, 24b, and 24c to simultaneously view, with the use of the single display device 1, different video images containing respective contents.

(Insertion of Black Lines into Video Image)

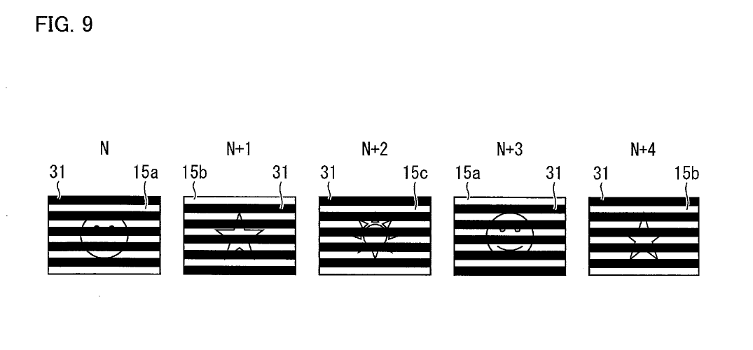

While the video signal controlling section 4 processes supplied video signals, the black line inserting section 3 inserts black lines 31 into video images. The following description will discuss the insertion of black lines 31. FIG. 9 is a view illustrating video images into which the black lines 31 are inserted in the embodiment of the present invention.

The black line inserting section 3 inserts horizontal black lines 31 into video images 15a, 15b, and 15c for respective viewers 24a, 24b, and 24c, each of which horizontal black lines 31 corresponds to 1 (one) horizontal line in a corresponding frame. In so doing, the black lines 31 are inserted into odd-numbered lines of any given video image while being inserted into even-numbered lines of a following video image. This causes black lines 31, which are inserted into a video image of any given frame, to be shifted by one line from black lines 31 which are inserted into a video image of a following frame.

Specifically, as illustrated in FIG. 9, (i) the black lines 31 are inserted into odd-numbered lines of video images of an Nth frame (which are video images 15a), (ii) the black lines 31 are inserted into even-numbered lines of video images of an (N+1)th frame (which are video images 15b intended for the viewer 24b), (iii) the black lines 31 are inserted into odd-numbered lines of video images of an (N+2)th frame (which are video images 15c), (iv) the black lines 31 are inserted into even-numbered lines of video images of an (N+3)th frame (which are video images 15a), and (v) the black lines 31 are inserted into odd-numbered lines of video images of an (N+4)th frame (which are video images 15b). Hence, the video signal controlling section 4 (i) generates a video signal configured such that each of video images 15a, each of video images 15b, and each of video images 15c, into each of which black lines 31 are inserted, are juxtaposed in this order and then (ii) supplies the video signal to the timing controlling section 8.

Note that each of black lines 31 is merely as extremely thin as a single horizontal line of a video image. This causes none of viewers 24a, 24b, and 24c to recognize the black lines 31 while the black lines 31 are displayed on the display panel 12. Therefore, although the overall brightness becomes somewhat dark, the video images 15a, 15b, and 15c, each of which contains the black lines 31, maintain their original display quality unlike the case without the black lines 31.

According to the display device 1 of Embodiment 3, even in a case where crosstalk occurs, (i) the video images 15a and 15b are never mixed with each other, (ii) the video images 15b and 15c are never mixed with each other, and (iii) the video images 15a and 15c are never mixed with each other. This causes none of viewers 24a, 24b, and 24c to perceive respective video images of a current frame and of a preceding frame being mixed with each other. In other words, the video images on the display panel 12 are properly displayed.

According to Embodiment 3, three different viewers can thus view their respective different video images each with reduced crosstalk even in a case where the three viewers simultaneously are viewing their respective video images on the single display device 1.

Note that the number of viewers to share the display device 1 is not limited to three, but can be four or more. In such a case, the display device 1 displays a video image in which a corresponding number (corresponding to the number of viewers) of video images are sequentially displayed, for each frame, one after another. In addition, according to a video signal configured as such, black lines 31 are inserted into odd-numbered lines of a video image, into even-numbered lines of a following video image, and into odd-numbered lines of a following video image, and so on. Since the display panel 12 displays video images based on such a video signal, all of viewers in attendance can view their respective video images each with reduced crosstalk, regardless of the number of viewers sharing the display device 1.

Note also that a larger number of viewers to view their respective different video images requires (i) a higher rate at which the display panel 12 displays a video image and (ii) a higher rate at which the respective pairs of shutter glasses are switched therebetween. If this is a case for a conventional display device 1, then the probability of crosstalk occurrence increases. With the ingenuity described above, however, it is possible to reduce the crosstalk occurrence even in a case of an increased number of viewers.

### Embodiment 4

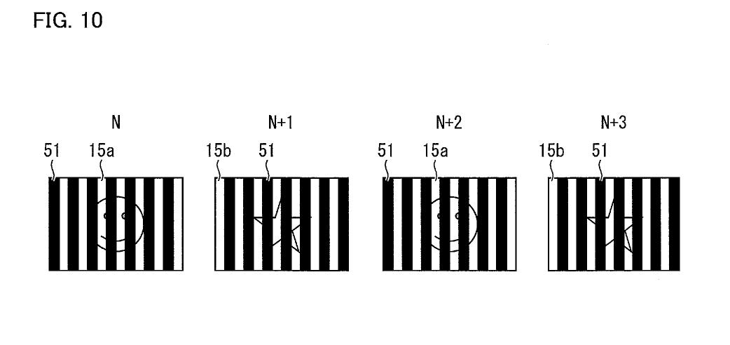

The following description will discuss Embodiment 4 of the present invention with reference to FIG. 10. Note that members, which are similar to those described in any of Embodiments 1 through 3 are given the same reference signs, and their detailed descriptions will be omitted.

According to Embodiment 4, unlike Embodiments 1 through 3, a black line inserting section 3 inserts vertical black lines 51 (each of which extends in a columnar direction) into each video image included in a video signal. Specifically, the black line inserting section 3 inserts, into video images 15a for a viewer 24a and into video images 15b for a viewer 24b, vertical black lines 51 each of which corresponds to 1 (one) vertical line of a corresponding video image 15a or 15b. In so doing, the black lines 51 are inserted into odd-numbered lines of the video images 15a while being inserted into even-numbered lines of the video images 15b. This causes black lines 51, which are inserted into a video image of any given frame, to be shifted by one vertical line from black lines 51 which are inserted into a video image of a following frame, according to a processed video signal.

FIG. 10 is a view illustrating a video signal in accordance with Embodiment 4. As illustrated in FIG. 10, the black lines 51 are inserted into odd-numbered lines of video images of an Nth frame and an (N+2)th frame, which are video images 15a intended for the viewer 24a. On the other hand, the black lines 51 are inserted into even-numbered lines of video images of an (N+1)th frame and an (N+3)th frame, which are video images 15b intended for the viewer 24b. A video signal controlling section 4 (i) generates a video signal in which video images 15a containing black lines 51 and video images 15b containing black lines 51 are alternated as such and then (ii) supplies the video signal to a timing controlling section 8.

Note that each of black lines 51 is merely as extremely thin as a single vertical line of a video image. This causes neither viewer 24a nor viewer 24b to recognize the black lines 51 while the black lines 51 are being displayed on a display panel 12. Therefore, although the overall brightness becomes somewhat dark, the video images 15a containing the black lines 51 and the video images 15b containing the black lines 51 maintain their original display quality unlike the case without the black lines 51.

Since the display device 1 displays video images with the use of the video signal illustrated in FIG. 3, neither the viewer 24a nor 24b perceives the occurrence of crosstalk on the displayed video images. That is, the black lines 51, which are inserted in a vertical direction of video images, bring about advantageous effects similar to those brought about by the black lines 31 which are inserted in a horizontal of video images in Embodiment 1.

### Embodiment 5

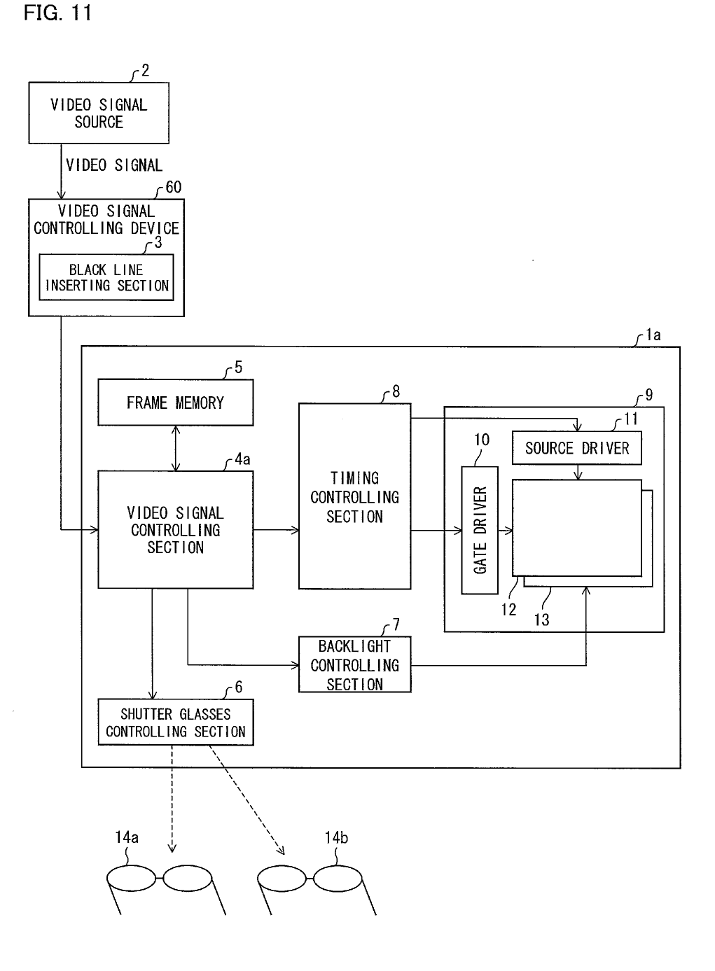

The following description will discuss Embodiment 5 of the present invention with reference to FIG. 11. Note that members, which are similar to those described in any of Embodiments 1 through 4 are given the same reference signs, and their detailed descriptions will be omitted.

FIG. 11 is a block diagram illustrating a main configuration of a display system in accordance with Embodiment 5 of the present invention. As illustrated in FIG. 11, the display system of Embodiment 5 includes a display device 1a, a video signal source 2, shutter glasses 14a, shutter glasses 14b, and a video signal controlling device 60. Unlike the video signal controlling section 4 of Embodiment 1, a video signal controlling section 4a, which is included in the display device 1a, does not include a black line inserting section 3. Such a black line inserting section 3 is included not in the display device 1a, but in the video signal controlling device 60.

(Video Signal Controlling Device 60)

The video signal controlling device 60 is connected to the video signal source 2 and to the display device 1a. Video signals, which have been outputted from the video signal source 2, are supplied not to the display device 1a but to the video signal controlling device 60. Then, the video signal controlling device 60 carries out various kinds of signal processing with respect to the video signals. The processing is basically identical to that carried out by the video signal controlling section 4 of Embodiments 1 through 3. In other words, the video signal controlling device 60 carries out various kinds of signal processing with respect to the video signals which have been supplied from the video signal source 2. This causes the video signals to be converted into a video signal capable of dual-view display. Specifically, (i) the video signals supplied from the video signal source 2 are video signals for respective first and second viewers and (ii) the video signal controlling device 60 converts the video signals so that (a) video images contained in the video signal for the first viewer and (b) video images contained in the video signal the second viewer, are alternated in a converted video signal. In other words, the video signal controlling device 60 generates a video signal for displaying the video images for the respective first and second viewers alternately and time-divisionally.

While the video signal controlling device 60 carries out video processing with respect to the supplied video signals, the black line inserting section 3 inserts black lines 31 into the video images. In this regard, the black line inserting section 3 is identical to the black line inserting section 3 which is included in the display device 1 in accordance with each of Embodiments 1 through 4.

The video signal controlling device 60 supplies a processed video signal to the display device 1a. This causes the display device 1a to receive a video signal in which the insertion of the black lines 31 has already been carried out. This allows the display device 1a to display a video image with the use of the supplied video signal as it is without carrying out, with respect to the supplied video signal, such signal processing as that carried out by the black line inserting section 3. Therefore, (i) it is possible to lighten a processing load of the display device 1a and (ii) it is possible for the display device 1 to display, without including the black line inserting section 3 therein, video images with reduced crosstalk as would be the case where the display device 1a included the black line inserting section 3 therein.

To summarize the video signal controlling device 60 of Embodiment 5, the video signal controlling device 60 is a video signal controlling device for processing a video signal which indicates video images in respective frames, including: a grayscale line inserting section for (i) inserting first grayscale lines, each of which has a color of certain grayscale and has a width corresponding to a certain number of pixels, into each of first video images such that a certain distance is secured, between the respective first grayscale lines, in a vertical or horizontal direction of each of the first video images and (ii) inserting second grayscale lines into each of second video images, which corresponds to a certain number of frames and by which a corresponding one of the first video images is followed, such that the second grayscale lines are not inserted into second parts corresponding to first parts where the respective first grayscale lines are inserted.

(Modifications)

The present invention is not limited to the description of the embodiments, but can be altered in many ways by a person skilled in the art within the scope of the claims. An embodiment derived from a proper combination of technical means disclosed in different embodiments is also encompassed in the technical scope of the present invention.

(Color of Inserted Lines)

Lines, which the black line inserting section 3 inserts into video images contained in a video signal, are not necessarily limited to black lines (i.e. not limited to black lines 31). In fact, lines of any grayscale (i.e. gray color) other than black can be inserted into the video images. In this regard, the display device 1a is considered to include a grayscale line inserting section for inserting grayscale lines of any grayscales into video images included in a video signal.

(Insertion Pitch of Lines)

Black lines 31, which the black line inserting section 3 inserts into video images 15a and 15b, do not necessarily need to be inserted in the form of lines each of which is separate from another. An insertion pitch of the black lines 31 can be properly set in accordance with a size of the screen of the display panel 12 and with a resolution of the display panel 12. For example, the insertion pitch can be configured by sets of two lines. In a case where a definition of the display panel 12 is as ultra-high as 4K×2K (3840 pixels×2160 pixels), the display panel 12, even with the black lines 31 inserted in sets of two lines into video images, has the definition identical to that of a full high-definition display panel into which black lines are inserted in the form of lines each of which is separated from one another. This means that neither a viewer 24a nor a viewer 24b perceives the black lines 31 which are inserted in a set of two lines.

(Other Configurations)

It is preferable to configure the video signal controlling device such that: each of the respective certain numbers of frames, to which the first and second video images correspond, is one; the each of the first video images, which corresponds to the certain number of frames, is intended for a first viewer; and the each of the second video images, which corresponds to the certain number of frames, is intended for a second viewer who is different from the first viewer.

According to the configuration, a video signal, which has been processed by the video signal controlling device, is configured so that positions, into which grayscale lines are inserted, are switched for each frame. This makes it possible to prevent any crosstalk from occurring between any two adjacent frames. Therefore, in a case where the video signal controlling device processes a video signal in which respective video images for first and second viewers are mixed with each other in each frame, the first and second viewers can each view a video image with reduced crosstalk.

It is preferable to configure the video signal controlling device such that: each of the respective certain numbers of frames, to which the first and second video images correspond, is two; the each of the first video images, which corresponds to the certain number of frames, is intended for a first viewer; and the each of the second video images, which corresponds to the certain number of frames, is intended for a second viewer who is different from the first viewer.

According to the configuration, a video signal, which has been processed by the video signal controlling device, is configured so that positions, into which grayscale lines are inserted, are switched for every two frames. In addition, respective video images for first and second viewers are switched for every two frames. Therefore, in a case where the video signal controlling device displays video images in such a manner, first video images of two adjacent frames and second video images of two adjacent frames are alternated. It is thus possible to prevent, by consecutively displaying the same video images, crosstalk from occurring while video images are displayed. Furthermore, a crosstalk-reduction effect by insertion of the grayscale lines can also be obtained at the same time. Therefore, a synergistic effect on reduction in crosstalk can be obtained.

It is preferable to configure the video signal controlling device such that the width corresponding to a certain number of pixels is equal to a width corresponding to a single line of pixels, and the certain distance secured between the respective first grayscale lines or between the respective second grayscale lines is equal to a distance corresponding to the single line of pixels.

According to the configuration, grayscale lines, each of which is as thin as possible, are inserted into video images. Therefore, even in a case where video images with a lower resolution are displayed, it is still possible to reduce the occurrence of crosstalk without compromising the display quality of the video images.

It is preferable to configure the video signal controlling device such that each of the first and second grayscale lines is black.

A display device of the present invention includes any one of the above display system controlling devices.

According to the configuration, it is possible to bring about such an advantageous effect as displaying video images with reduced crosstalk.

The embodiments and the concrete examples, which have been discussed in the detailed description, are illustrative only, which should not be narrowly interpreted within the limits of such embodiments and concrete examples, but are rather meant to be applied in any variations within the spirit of the present invention, provided that such variations do not exceed the scope of the patent claims set forth below.

### INDUSTRIAL APPLICABILITY

The present invention can be put to a wide range of use as a video signal controlling device for processing video signals which have been outputted from a video signal source.

### REFERENCE SIGNS LIST

1 Display device
1a Display device
2 Video signal source
3 Black line inserting section
4 Video signal controlling section
4a Video signal controlling section
5 Frame memory
6 Shutter glasses controlling section
7 Backlight controlling section
8 Timing controlling section
9 Display section
10 Gate driver
11 Source driver
12 Display panel
13 Backlight
14a through 14c Shutter glasses
15a through 15c Video image
24a through 24c Viewer
30a through 30c Video data
31 Black lines
60 Video signal controlling device

1. A video signal controlling device for processing a video signal which indicates video images in respective frames, comprising:
a grayscale line inserting section for (i) inserting first grayscale lines, each of which has a color of certain grayscale and has a width corresponding to a certain number of pixels, into each of first video images such that a certain distance is secured, between the respective first grayscale lines, in a vertical or horizontal direction of each of the first video images and (ii) inserting second grayscale lines into each of second video images, which corresponds to a certain number of frames and by which a corresponding one of the first video images is followed, such that the second grayscale lines are not inserted into second parts corresponding to first parts where the respective first grayscale lines are inserted.

2. The video signal controlling device as set forth in claim 1, wherein:
the first video images are intended for a first viewer; and
the second video images are intended for a second viewer who is different from the first viewer.

3. The video signal controlling device as set forth in claim 1, wherein:
each of the respective certain numbers of frames, to which the first and second video images correspond, is two;
the each of the first video images, which corresponds to the certain number of frames, is intended for a first viewer; and
the each of the second video images, which corresponds to the certain number of frames, is intended for a second viewer who is different from the first viewer.

4. The video signal controlling device as set forth in claim 1, wherein the width corresponding to a certain number of pixels is equal to a width corresponding to a single line of pixels, and the certain distance secured between the respective first grayscale lines or between the respective second grayscale lines is equal to a distance corresponding to the single line of pixels.

5. The video signal controlling device as set forth in claim 1, wherein each of the first and second grayscale lines is black.

6. A method of processing a video signal which indicates video images in respective frames,
said method comprising the step of:
(i) inserting first grayscale lines, each of which has a color of certain grayscale and has a width corresponding to a certain number of pixels, into each of first video images such that a certain distance is secured, between the respective first grayscale lines, in a vertical or horizontal direction of each of the first video images and (ii) inserting second grayscale lines into each of second video images, which corresponds to a certain number of frames and by which a corresponding one of the first video images is followed, such that the second grayscale lines are not inserted into second parts corresponding to first parts where the respective first grayscale lines are inserted.

7. A display device comprising a video signal controlling device as set forth in claim 1.
